(19) United States
(12) Patent Application Publication
(10) Pub. No.: US 2004/0160047 A1
(43) Pub. Date: Aug. 19, 2004

(54) Airbag module

(75) Inventor: Thomas Marotzke, Bergfelde (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/724,396

(22) Filed: Dec. 1, 2003

Related U.S. Application Data
(63) Continuation of application No. PCT/DE02/02787, filed on Jul. 25, 2002.

(30) Foreign Application Priority Data
Jul. 25, 2001 (DE) 101 36 893.3

(51) Int. Cl. B60R 21/28

(52) U.S. Cl. 280/741

(57) ABSTRACT

An airbag module including a generator carrier having a base for fastening a gas generator. The carrier also includes at least one boundary wall which projects from the base and is integrally formed in one piece on the base and which, together with the base, forms a receptacle for a folded gas bag. The module also includes a cover for covering an outlet orifice for a deploying gas bag. At least one portion of the boundary wall is pivotably connected to the base part so that the boundary wall can pivot and thereby create a free space for the deploying gas bag.

### CROSS-REFERENCE TO RELATED APPLICATIONS

This is a continuation of International Application PCT/DE02/02787, which has an international filing date of Jul. 25, 2002; this International Application was not published in English, but was published in German as WO 03/011655.

### BACKGROUND

The invention relates to generally to an airbag module, and in particular to a driver's side airbag module. A typical module includes a generator carrier, which has a base for fastening a gas generator, and at least one boundary wall which projects from the base and is integrally formed in one piece on the base and, together with the base, forms a receptacle for a folded gas bag inflatable by means of a gas generator.

Such an airbag module, in which the generator carrier forms at the same time a receptacle for the gas bag of the airbag module, makes it possible, because of the high rigidity of the gas bag receptacle (corresponding to the particular stability of the material of which a generator carrier normally consists), to fold the gas bag together to a particularly small packed volume, because the gas bag receptacle can absorb correspondingly high expansion forces. The airbag module as a whole can therefore be made highly compact. However, there is the problem that the rigidity of the gas bag receptacle contradicts the requirement for making as compliant an environment as possible available to the gas bag for good airbag functioning during deployment.

There remains a need to provide an airbag module including a gas bag receptacle of which, on the one hand, can absorb high expansion forces, preferably without being deformed, and which, on the other hand, forms a sufficiently compliant environment for the deploying gas bag.

### SUMMARY OF THE INVENTION

According to an embodiment of the present invention an airbag module is provided. The module includes a generator carrier which has a base for fastening a gas generator, at least one boundary wall which projects from the base part and is integrally formed in one piece on the base and which, together with the base, forms a receptacle for a folded-together gas bag inflatable by means of the gas generator, and a module cover for covering an outlet orifice for a deploying gas bag, at least one portion of the boundary wall being connected pivotably to the base part and, as a result of pivoting, releasing a free space for the deploying gas bag. Accordingly, at least one portion of the boundary wall of the generator carrier is connected pivotably to the base of the generator carrier, so that, during the deployment of the gas bag, the pivoting of this wall portion releases a free space (orifice), through which the gas bag can emerge in the lateral direction during deployment.

According to an embodiment of the present invention, an air bag module in which the gas bag receptacle is formed by the generator carrier itself and therefore has a correspondingly stable configuration is provided. This embodiment allows an initial deployment of the gas bag not only through an outlet orifice located opposite the base, but also in the lateral direction. This is made possible by the fact that, during the deployment of the gas bag, at least one portion of the lateral boundary wall of the gas bag receptacle is pivoted in such a way that an orifice for the lateral deployment of the gas bag is released.

Thus, the present invention provides a rigid a gas bag receptacle while also ensuring as compliant an environment as possible for the gas bag during the triggering of the airbag module.

Conventionally, the outlet orifice of the gas bag receptacle, the outlet orifice being located opposite the base, is covered by a plastic module cover which, during the deployment of the gas bag, releases the outlet orifice for the deploying gas bag (for example, as a result of the pivoting of parts of the module cover). According to another embodiment of the present invention, as a result of the pivoting of at least one portion of the lateral boundary wall of the gas bag receptacle, an additional orifice for a lateral deployment of the gas bag is also released.

The module cover is preferably formed by a subassembly which is separate from the receptacle comprising the generator carrier and boundary wall and which is connected to the receptacle, for example materially by adhesive bonding or positively by latching or riveting. By the separate formation of the cover consisting preferably of a different (softer) material from the receptacle, for example of plastic, the sought-after advantages of a high packing density, along with low tolerances, can be achieved to a special degree.

The outlet orifice of the gas bag receptacle defines a main deployment direction, along which the gas bag can be deployed toward an occupant, while the additional orifice occurring as a result of the pivoting of a lateral wall portion of the gas bag receptacle makes it possible, moreover, to have an (initial) deployment of a part of the gas bag in a lateral direction, essentially perpendicularly to the main deployment direction.

According to one embodiment of the invention, the receptacle for the gas bag is formed by a completely continuous boundary wall, together with the base of the generator carrier. According to this embodiment, the receptacle is essentially a bowl-shaped receptacle.

According to another embodiment of the invention, the boundary wall of the gas bag receptacle includes at least two wall regions spaced apart from one another three-dimensionally, as a result of which, for example, an essentially U-shaped receptacle can be formed for the gas bag.

The pivotable wall portion can be connected in one piece to the base of the generator carrier, for example, via a film hinge, the film hinge allowing the pivoting of the wall portion during the deployment of the gas bag.

According to another variant, the pivotable wall portion is separated, along part of its end facing the base (and via which this wall portion is connected to the base), from the base by slots. The connection between the pivotable wall portion of the base is weakened by the slots, so that a pivoting of the wall portion during the deployment of the gas bag becomes possible.

The pivoting of a wall portion of the gas bag receptacle is triggered by means of the forces occurring during the deployment of the gas bag, which may take place, on the one hand, due to the direct action of the gas bag on this wall portion or, on the other hand, by means of the opening module cover. In the last-mentioned instance, the module cover is connected to the pivotable wall portion in such a way that it triggers the desired pivoting movement of the wall portion when the deploying gas bag acts on the module cover.

Preferably, the generator carrier (gas bag receptacles) is configured in such a way that the at least one pivotable wall portion of the gas bag receptacle can be pivoted under the forces acting during the inflation and deployment of the gas bag, while the (lower) expansion forces of the folded gas bag prior to the triggering of the airbag module cannot trigger such a pivoting movement. For this purpose, means are provided, which counteract a pivoting of the at least one pivotable wall portion, so that the one pivotable wall portion can execute a pivoting movement only when sufficiently high forces act on the pivotable wall portion during the inflation and deployment of the gas bag arranged in the gas bag receptacle.

According to a first embodiment, the means which counteract a pivoting of the pivotable wall portion are integrated in one piece into the generator carrier. For this purpose, there may be provision, for example, for the pivotable wall portion to be connected to further regions of the lateral boundary wall via a weakening region formed, for example, by a perforation or via an overlap region.

According to another embodiment, at least one separate element is provided, which counteracts a pivoting of the pivotable wall portion. For this purpose, a ring may be provided, which surrounds the boundary wall and has at least one weakening region, so that it can be widened or destroyed during the deployment of the gas bag, in order to allow a pivoting of the at least one pivotable wall portion. In this instance, the pivotable wall portion may simply be separated from the remaining regions of the lateral boundary wall by a free space, in particular by slots. Instead of a ring, a suitable connection means may also be used, which connects the pivotable wall portion to a further region of the lateral boundary wall.

Finally, the connection between the pivotable boundary wall and the base of the gas bag receptacle may be configured in such a way that it allows a pivoting of the boundary wall only under the action of the forces of the gas bag which deploys during inflation.

In a preferred embodiment of the invention, the lateral boundary wall of the gas bag receptacle includes two pivotable wall portions which are arranged opposite one another and which in each case release a lateral orifice during the deployment of the gas bag.

It is to be understood that both the foregoing general description and the following detailed description are exemplary and explanatory only and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1a shows a section through an airbag module with a generator carrier which at the same time forms a receptacle for a gas bag.

FIG. 1b shows the airbag module from FIG. 1A after triggering in a crash situation.

FIG. 2 shows a first embodiment of a bowl-shaped generator carrier for an airbag module according to FIG. 1a.

FIG. 3 shows a second embodiment of a bowl-shaped generator carrier for an airbag module according to FIG. 1a.

FIG. 4 shows a third embodiment of a bowl-shaped generator carrier for an airbag module according to FIG. 1a.

FIG. 5 shows a fourth embodiment of a bowl-shaped generator carrier for an airbag module according to FIG. 1a.

FIG. 6 shows a generator carrier of U-shaped cross section for an airbag module according to FIG. 1a.

### DETAILED DESCRIPTION

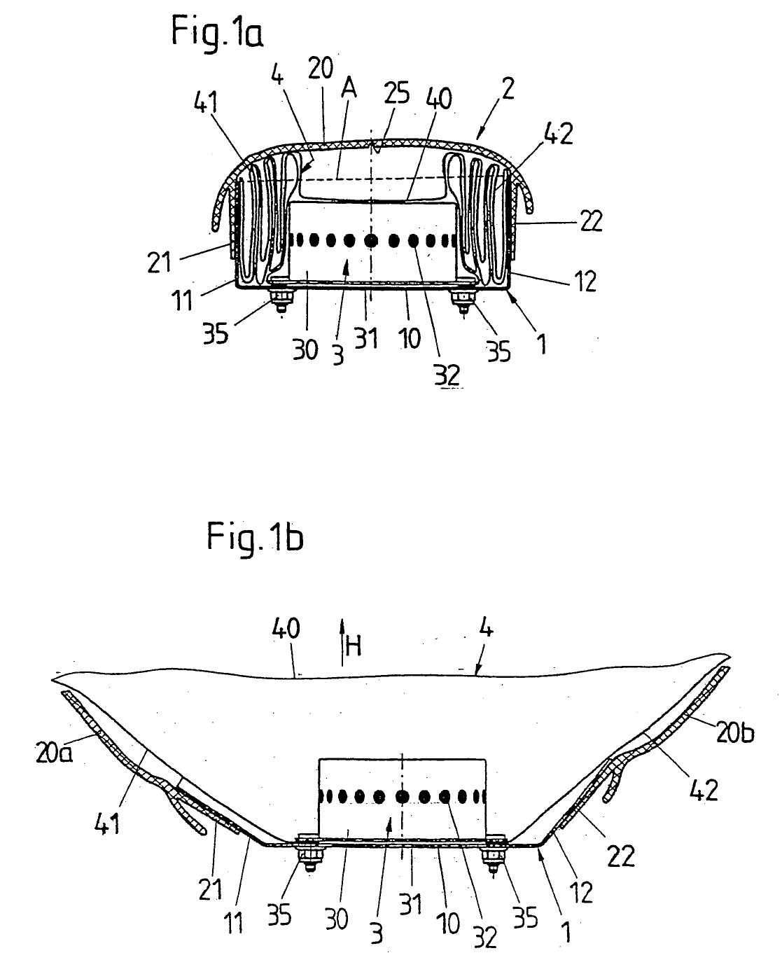

FIG. 1a illustrates a driver's airbag module which has a generator carrier 1 which consists of a stable material, in particular of metal, and to the plate shaped base 10 of which a gas generator 3 is fastened via a fastening flange 31 by means of fastening screws 35. The base 10 and the generator carrier 1 thus serves for receiving and fastening the gas generator 3.

A boundary wall having two wall portions 11, 12 located opposite one another projects upward from the plate-shaped base 10 and the generator carrier 1. The wall portions 11, 12, projecting essentially perpendicularly from the base 10, form, together with the base 10, a bowl-shaped receptacle for a gas bag 4 which is inflatable by means of the gas generator 3.

The gas bag 4 is clamped, in the region of its injection mouth, between the base 10 of the generator carrier 1 and the generator flange 31, and the gas generator 3 is arranged within the gas bag 4.

By virtue of the high stability of the bowl shaped gas bag receptacle which is formed by the base 10 of the generator carrier 1 together with the wall portions 11, 12 integrally formed in one piece thereon, the gas bag 4 can be stowed away, in a state in which it is compressed to a very small pack volume, in the gas bag receptacle. This is indicated in FIG. 1a by the very close packing of the individual plies of the gas bag in the regions 41, 42 between the housing 30 of the gas generator 3 and the two wall portions 11, 12 of the gas bag receptacle. By virtue of its high rigidity, the gas bag receptacle can absorb the comparatively high expansion forces of a gas bag 4 compressed to a very small pack volume.

Furthermore, the rigid design of the gas bag receptacle is advantageous for use as a driver's airbag module in steering wheels, in which the functioning of the horn may be triggered by pressure on the module cover. Accordingly, for design and operating reasons, stringent requirements as to gap damage and tolerances have to be satisfied. By means of a rigid design of the gas bag receptacle, tolerance fluctuations and deformations, particularly as a result of the expansion forces of the folded airbag and as a result of actuating forces, can in this case be minimized.

As can be seen from FIG. 1a, in the present case, a module cover 2 of the airbag module is formed by a separate cap 20 which preferably consists of plastic and which covers the outlet orifice A of the bowl-shaped gas bag receptacle, the outlet orifice being located opposite the base 10. Sidewalls 21, 22 project downward from the lateral ends of the cap 20 and are connected in each case to a wall portion 11 or 12 of the boundary wall of the generator carrier 1, for example materially by adhesive bonding or positively by latching or riveting. Furthermore, the cover cap 20 has at its center weakening regions 25, along which the cap 20 can tear open during the deployment of the gas bag 4, in order to allow the deploying gas bag 4 to emerge from the airbag module.

When the airbag module illustrated in FIG. 1a is triggered by the ignition of the gas generator 3, gases emerge through outflow orifices 32 in its housing 30, the gas bag 4 being filled with these gases so that it is deployed out of the state shown in FIG. 1a. Accordingly, a gas bag ply 40 lying on the topside of the gas generator 3 lifts off upward in the direction of the cap 20. Furthermore, the lateral portions 41, 42 of the gas bag package are pressed not only upward in the direction of the cap 20, but also laterally outward, by the gases flowing into the gas bag.

As a result of the forces of the deploying gas bag 4 which act on the cap 20, the cap tears open along the weakening region 25 and is separated into two cap portions 28, 20b which, according to FIG. 1b, pivot outward under the pressure of the deploying gas bag 4. As a result, the gas bag can be deployed toward the occupant to be protected along a main deployment direction H which is defined by the outlet orifice A of the bowl-shaped gas bag receptacle, the outlet orifice being located opposite the base 10.

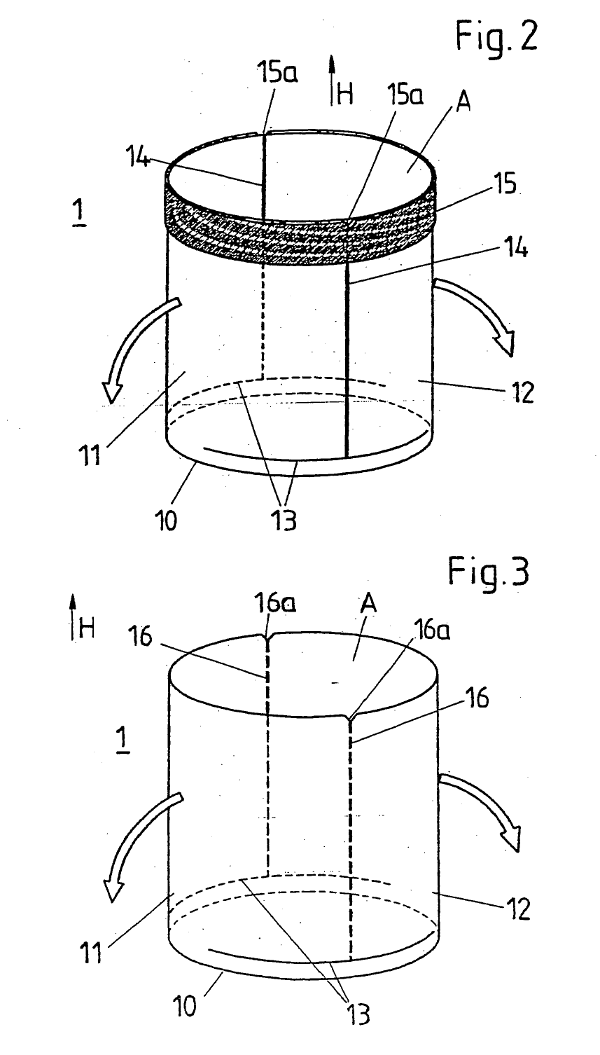

In the present case, however, not only is the upper outlet orifice A released as a result of the pivoting of the cap portions 20a, 20b, but these at the same time take along the two wall portions 11, 12 of the gas bag receptacle. This is made possible by the fact that the two wall portions 11, 12 are connected pivotably to the base 10 of the generator carrier 1, as will be explained in more detail below with reference to FIGS. 2 to 4.

A deployment of the gas bag 4 not only along the main deployment direction H, but also in a lateral direction (essentially perpendicularly to the main deployment direction H) thereby becomes possible. That is to say, during deployment, at least parts of the gas bag 4 do not initially move along the main deployment direction H, but essentially perpendicularly to this in a lateral direction.

In summary, the gas bag receptacle formed by the generator carrier 1 is configured in such a way that it is designed rigidly in the axial direction, opposite to the main deployment direction, whereas forces acting radially outward can trigger a pivoting of the wall portions 11, 12 of the lateral boundary wall of the gas bag receptacle. What is achieved thereby is that compliance of the environment of the gas bag during the triggering of the airbag which is sought after and advantageous for good airbag functioning both in the normal situation (the occupant to be protected is in the normal position) and in an oop situation (the occupant to be protected is bent forward in the direction of the airbag module). At the same time, a highly stable gas bag receptacle in the form of the gas generator carrier 1 is made available, which can receive a small pack volume and absorb correspondingly high expansion forces of the compressed gas bag.

FIG. 2 shows a first exemplary embodiment of a generator carrier 1 of bowl-shaped design which forms a gas bag receptacle for an airbag module.

The generator carrier 1 has a plane, circular base 10 for receiving and fastening a gas generator and also two wall portions 11, 12 which project essentially perpendicularly from it and form a continuous boundary wall of the generator carrier 1. The two wall portions 11, 12 are configured identically, are arranged opposite one another and are separated from one another by two slots 14. Furthermore, those end regions of the wall portions 11, 12 which face the base 10 are separated partially from the base 10 by slots 13. There is consequently only a partial connection between the wall portions 11, 12 and the base 10 of the generator carrier 1. This makes it possible, during the deployment of a gas bag located in the gas bag receptacle, to have an outward pivoting of the two wall portions 11, 12 according to the arrows illustrated in FIG. 2.

The pivoting of the two wall portions 11, 12 of the generator carrier 1 as a result of expansion forces of a gas bag is counteracted by a ring 15 which completely surrounds the two wall portions 11, 12 on the outside. The ring 15 is provided with two weakening regions 15a in the form of indentations, so that it can be destroyed under the action of high forces during the inflation and deployment of the gas bag, in order to make it possible for the wall portions 11, 12 to pivot outward.

Since the gas bag receptacle formed by the generator carrier 1 consists in one piece of the material of the highly stable base 10 of the generator carrier 1, it forms a correspondingly rigid receptacle for a gas bag. At the same time, during the triggering of the airbag, it forms a sufficiently soft environment of the gas bag, since, under the action of the forces occurring during the deployment of a gas bag, the two lateral wall portions 11, 12 pivot outward and thus allow not only a deployment of the gas bag along a main deployment direction H through the outlet orifice A located opposite the base 10, but also an outward deployment of parts of the gas bag in a lateral direction.

FIG. 3 shows a modification of the exemplary embodiment according to FIG. 2, the difference being that the two wall portions 11, 12 of the generator carrier 1 are not separated from one another by slots, but by perforation lines 16. Accordingly, the use of an additional ring (as provided in the exemplary embodiment according to FIG. 2) for stabilizing the gas bag receptacle in the radial direction is not necessary. Instead, the perforations 16 are designed in such a way that they cannot tear open due to the pressure acting by virtue of the expansion forces of the folded gas bag, but only due to the substantially higher pressure forces occurring during the filling and deploying of the gas bag. In order to ensure a defined tearing open of the perforations 16 during the deployment of a gas bag, the perforations 16 issue at their end facing away from the base 10 in each case into indentations 16a.

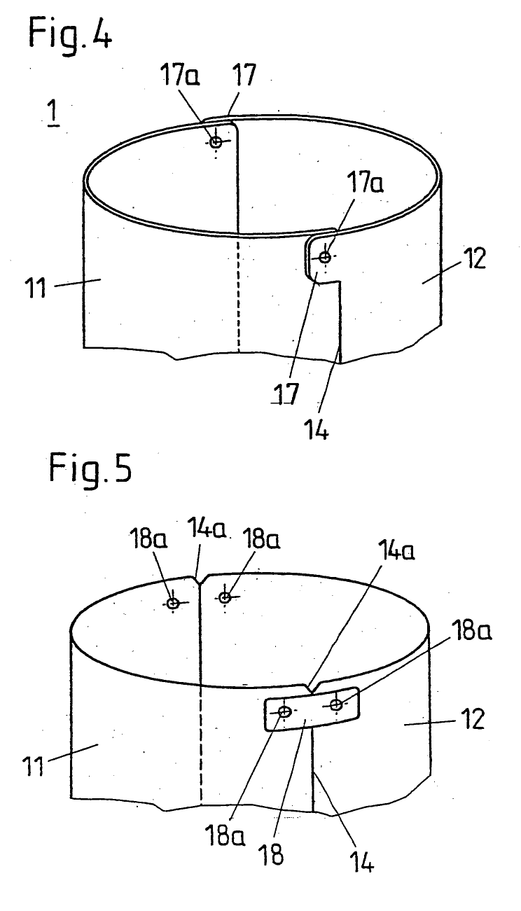

FIG. 4 illustrates a modification of the generator carrier 1 shown in FIGS. 2 and 3, in which two overlap regions 17 are provided, which are in each case integrally formed in one piece as tabs on one pivotable wall portion 12. In the overlap regions 17, the two wall portions 11, 12 are connected to one another in each case by a fastening means 17a.

Accordingly, the overlap regions 17 and/or the fastening means 17a are designed in such a way that they withstand the expansion forces of a folded gas bag arranged in the gas bag receptacle formed by the generator carrier 10, but not the forces occurring during the deployment of the gas bag (after the triggering of the airbag module). As a result of the forces during deployment, the connection between the overlap regions 17 of one pivotable wall portion 12 and the other pivotable wall portion 11 is broken, for example by shearing off, tearing out, unlatching or the destruction of the fastening means 17a or by the destruction of the tab-like overlap region 17.

The fastening means 17a may in this case be formed both by separate connection elements, for example in the form of pins or screws, and by connection elements integrally formed on the wall portions 11, 12, for example in the form of latching elements or hooks.

In the exemplary embodiment of a bowl-shaped generator carrier according to FIG. 5, the two pivotable wall portions 11, 12 are connected to one another via separate connecting webs or connecting tabs 18 which again are fastened to the pivotable wall portions 11, 12 by suitable fastening means 18a. Suitable fastening means are in this case, for example, the connection elements which have already been mentioned with reference to FIG. 4. Here, too, the connection between the two pivotable wall portions 11, 12 is designed in such a way that it can withstand the expansion forces of a folded gas bag, but not the forces occurring during deployment. In order to make it easier for the wall portions 11, 12 to pivot under the action of the last mentioned forces, the slot 14 between the two wall portions 11, 12 issues in each case into a funnel like widening 14a at the upper end of the bowl shaped generator carrier 1. The release of the connection between the two wall portions 11, 12 may be based on the same causes as those presented for the overlap region 17 with reference to FIG. 4.

Furthermore, the connecting web 18a itself may have an indentation or another weakening region, in order to initiate a destruction of the connecting web 18a under the action of the forces occurring during the deployment of a gas bag.

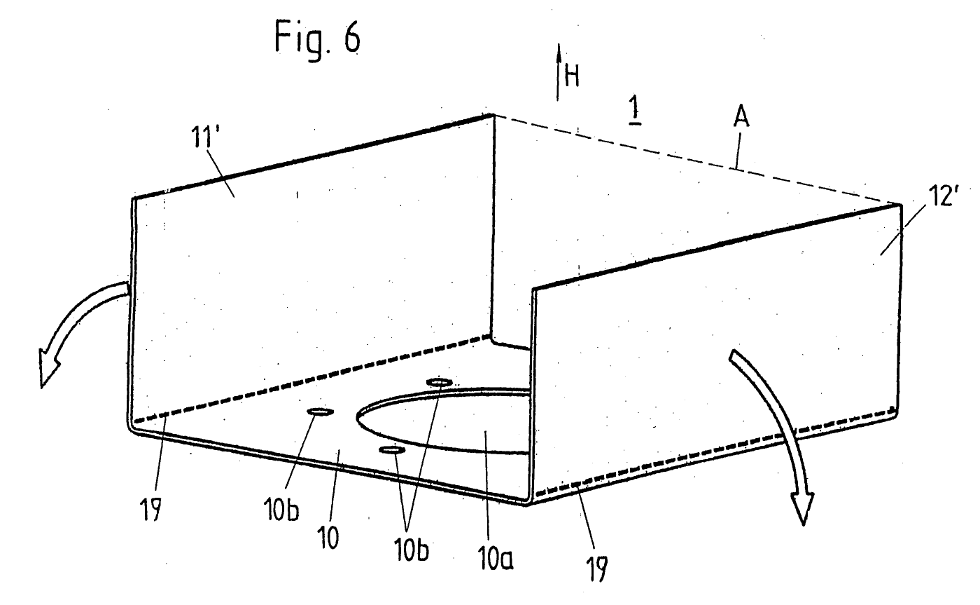

FIG. 6 shows a further exemplary embodiment of a gas bag receptacle which is formed by a generator carrier 1.

According to FIG. 6, the base 10 of the generator carrier 1 is of rectangular design and has a reception orifice 10a and fastening points 10b for receiving and fastening a circular gas generator. The base 10 has formed on it in one piece two likewise rectangularly designed wall portions 11′, 12′ which project perpendicularly from the base 10 and which form a lateral boundary wall of the generator carrier 1. Here the two wall portions 11′, 12′ are connected to the base 10 in each case via a hinge, in particular a film hinge 19, and are arranged opposite one another, so that the generator carrier 1 has in cross section an essentially U-shaped configuration. The film hinge 19 is in this case designed in such a way that it allows a pivoting of the wall portions 11′, 12′ only under the action of sufficiently high forces, such as occur during the inflation and deployment of a gas bag.

Instead of a film hinge 19, another weakening region, for example a perforated region, may also be provided. Furthermore, in this exemplary embodiment, the pivotable wall portions 11′, 12′ may also be connected to one another by means of a continuous ring or connecting webs.

The generator carrier 1 thus forms an essentially U-shaped receptacle for a gas bag, which, during the inflation of the gas bag, allows not only a deployment along a main deployment direction H (through an orifice A located opposite the base 10), but also a deployment of parts of the gas bag essentially perpendicularly thereto in a lateral direction. For this purpose, the two wall portions 11′, 12′ can be pivoted outward by means of the pressure of the deploying gas bag according to the arrows illustrated in FIG. 6.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An airbag module comprising:
a generator carrier including a base for fastening a gas generator, wherein the carrier includes at least one boundary wall which projects from the base and is integrally formed in one piece on the base and which, together with the base, forms a receptacle for a folded gas bag, and
a module cover for covering an outlet orifice for a deploying gas bag;
at least one portion of the boundary wall being pivotably connected to the base part so that the boundary wall can pivot and thereby create a free space for the deploying gas bag; and
wherein the module cover is formed by a separate cap which is connected to the at least one portion of the boundary wall.

2. The airbag module of claim 1, wherein the module cover is formed by a separate subassembly connected to the receptacle.

3. The airbag module of claim 2, wherein the module is configured so that during the deployment of a gas bag, the cover uncovers the outlet orifice for the deploying gas bag, and as a result of a pivoting of the at least one pivotable wall portion, an additional free space for the deploying gas bag is released.

4. The airbag module of claim 3, wherein the module is configured so that the orifice located opposite the base part defines a main deployment direction of the gas bag, and in that the additional free space allows a deployment of parts of the gas bag essentially perpendicularly to this main deployment direction.

5. The airbag module of claim 1, wherein the module includes a single completely continuous boundary wall.

6. The airbag module of claim 1, wherein the receptacle has a bowl-shaped design.

7. The airbag module of one of claim 1, wherein the boundary wall comprises at least two wall regions spaced apart from one another three-dimensionally.

8. The airbag module of claim 7, wherein the receptacle is of essentially U-shaped design.

9. The airbag module of claim 1, wherein the pivotable wall portion is articulated on the base via a film hinge.

10. The airbag module of claim 1, wherein the pivotable wall portion is separated, along part of its end facing the base, from the base by a slot or a perforation.

11. The airbag module of claim 1, wherein the pivotable wall portion is configured to pivot as a result of forces resulting from the deployment of the gas bag.

12. The airbag module of claim 11, wherein the pivotable wall portion is pivoted directly by the deploying gas bag.

13. The airbag module of claim 1, wherein the pivotable wall portion is configured to pivot due to the cover opening during the deployment of the gas bag.

14. The airbag module of claim 1, further comprising means for counteracting the pivoting of the wall portion.

15. The airbag module of claim 14, wherein the means for counteracting connects the pivotable wall portion to an additional wall portion of the receptacle.

16. The airbag module of claim 14, wherein the means for counteracting is integrated into the boundary wall.

17. The airbag module of claim 15, wherein the pivotable wall portion is connected to the additional wall portion by a perforated region or an overlap region.

18. The airbag module of claim 1, further comprising an element which counteracts a pivoting of the wall portion.

19. The airbag module of claim 18, wherein the element comprises a ring surrounding the wall portion.

20. The airbag module of claim 18, wherein element connects the pivotable wall portion to an additional wall portion of the receptacle.

21. The airbag module claims 19, wherein the ring includes a weakening region configured to be deformed or separated during the deployment of the gas bag, in order to permit the pivoting of the pivotable wall portion.

22. The airbag module of claim 1, wherein the pivotable wall portion is separated from further wall regions by a slot.

23. The airbag module of claim 1, wherein two pivotable wall portions are provided.

24. The airbag module of claim 23, wherein the two wall portions are arranged opposite one another.

25. An airbag module comprising:
an airbag;
a container for the airbag including a base and a side wall;
wherein the side wall is configured to move outwardly during deployment of the airbag to thereby permit outward deployment of the airbag in the container.

26. The airbag module of claim 25, further comprising a cover for the container.
